(19) United States
(12) Patent Application Publication
(10) Pub. No.: US 2002/0199189 A1
(43) Pub. Date: Dec. 26, 2002

(54) Methods and systems for insertion of supplemental video and audio content

(76) Inventors: Donald F. Prijatel, Westlake Village, CA (US); Timothy L. Crabtree, Yorba Linda, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/119,877

(22) Filed: Apr. 9, 2002

Related U.S. Application Data
(60) Provisional application No. 60/282,720, filed on Apr. 9, 2001.

(51) Int. Cl. H04N 7/10; H04N 7/025

(52) U.S. Cl. 725/36

(57) ABSTRACT

Systems and methods for inserting material into a transmission stream. In some embodiments an element inserter inserts tags, such as promotional tags, into a transmission stream based on transmission time considerations.

### CROSS-REFERENCE TO RELATED APPLICATION

This application claims the benefit of the filing date of U.S. Provisional Application No. 60/282,720, entitled Methods And Systems For Insertion Of Supplemental Video And Audio Content, filed Apr. 9, 2001, the disclosure of which is hereby incorporated by reference as if set forth in full herein.

### BACKGROUND

The present invention relates generally to insertion of video and audio content to video material, and more particularly to automatic insertion of supplemental video and/or audio content over a scheduled video element in a program stream, such as a television broadcast.

Within a television broadcast facility it is often necessary to add, or insert, supplemental information or content to certain video material once it arrives at the facility and prior to the transmission of the material. The nature of the supplemental content is typically information that is specific to that broadcast facility such as the local channel assignment for the broadcast transmissions or information about the transmission schedule for future events. This supplemental information is generally unique for each broadcast facility. In addition, the broadcast facility will often add a distinctive look to their broadcasts by inserting certain graphic elements such as a station logo and using an announcer with a distinctive voice for the supplemental content. In the television broadcast industry the supplemental content is often referred to as “tags” and they are most often required when broadcasting promotional information regarding upcoming programs, they are also often used with commercial advertising material to add local information to the commercial message.

In most television broadcast facilities today, tag material is inserted by editing onto the end of the promotional or commercial material in an edit suite using traditional video and audio editing techniques. This method requires the station personnel to gather the appropriate supplemental video and/or audio content and combine or edit this content onto the promotional or commercial material as it arrived from the program syndicator or ad agency. This editing operation results in a new, “tagged” video element that is now ready for transmission. If the transmission schedule requires several different types of tag material to be used with the same promotional or commercial material, the editing process must be repeated for each different version required. The resulting tagged elements must then be individually identified, stored and managed to produce the required combination of generic and supplemental elements as dictated by the transmission schedule.

This method of combining generic promotional or commercial video elements with local tag elements is time consuming for the highly skilled station personnel required to perform the necessary editing. Also, the required editing equipment is expensive and often in high demand to accomplish other tasks, such as editing news stories or the production of local commercial advertising. The combination of labor costs and capital equipment costs equates to a significant yearly expenditure in these facilities.

For more than 20 years, television broadcast facilities have employed computerized automation equipment to reduce the labor required to produce their transmissions. These systems have been very beneficial in automating regularly scheduled broadcasts of commercial and program material through computer control of the storage and switching devices used in producing the schedule of video elements. The automation systems, however, do not significantly alleviate problems with adding supplemental content to, for example, promotional spots. Moreover, use of the automation systems often suffer from two common problems:

1. The necessary programming information must be inserted into the transmission schedule for each element to be tagged. This requires a tedious and error-prone process to be performed by the operator for every scheduled transmission of a tagged element.

2. The programming operation, once done, is static, if the transmission schedule is changed or delayed, the combination of generic and tag elements chosen at the time of programming the automation system may no longer be valid. No context sensitive or time dependant algorithms currently exist to prevent an inappropriate tag selection from being transmitted.

Because of the these problems, few, if any, of the existing systems are actually used for the purpose of tagging promotional and commercial material in broadcast facilities today.

In addition, manual editing of tagged elements decreases a broadcasters ability to provided varied, including time sensitive, information regarding upcoming transmissions or in general. Moreover, flexibility in rearranging an intended transmission schedule may also be impacted by an inability to modify tag elements which might refer to or imply such a schedule.

### SUMMARY OF THE INVENTION

The present invention, therefore provides, in part:

1. A method for the automatic insertion of tag audio and/or video by programming the relationships between tag elements and generic elements one time to support multiple automated transmissions of these combined elements for as long as the selected relationships remain valid.

2. A method for providing automated algorithms for the selection of tag elements thereby allowing increased flexibility in the scheduling of complex tag sequences with very little additional effort on the part of station personnel.

3. Protection from the transmission of incorrect combinations of elements when the transmission schedule is changed or delayed.

In one aspect the invention provides a method for including material in a transmission stream, the method comprising determining a current content in the transmission stream; determining a time having an association with the current content; determining a current time; and inserting material associated with the current content into the transmission stream based on a relationship between the current time and the time having an association with the current content.

In another aspect the invention provides a broadcast system comprising at least one video source providing video content; means for determining a tag for use with the video content based on a current time and a time associated with the video content; and a combiner for combining the tag and the video content.

In another aspect the invention provides, in a system for providing a transmission stream including video content, the transmission of video content in the transmission stream being set by a program schedule, the video content comprising promotional content and program content, the promotional content relating to the program content, a system for including tags in the promotional content, the system comprising a tag store storing tags; a database including information identifying a relationship between tags, promotional content, and program content; a control receiving an indication of video content in the transmission stream, the control selecting a tag from the tag store using the indication of video content in the transmission stream and information contained in the database; and a combiner combining the selected tag with the video content in the transmission stream.

These and other aspects of the invention will be more fully comprehended upon review of this disclosure and the accompanying figures.

### BRIEF DESCRIPTION OF THE DRAWINGS

FIG. 1 is a block diagram of a video and audio tag insertion system in accordance with aspects of the invention;

FIG. 2 is a block diagram of an alternate embodiment of a system in accordance with aspects of the invention;

FIG. 3 is a functional block diagram of an embodiment of an element inserter;

FIG. 4 is a data diagram of example data in accordance with aspects of the invention;

FIG. 5 is a block diagram of aspects of a further embodiment of the invention; and

FIG. 6 is a flow diagram of a process in accordance with aspects of the invention.

### DETAILED DESCRIPTION

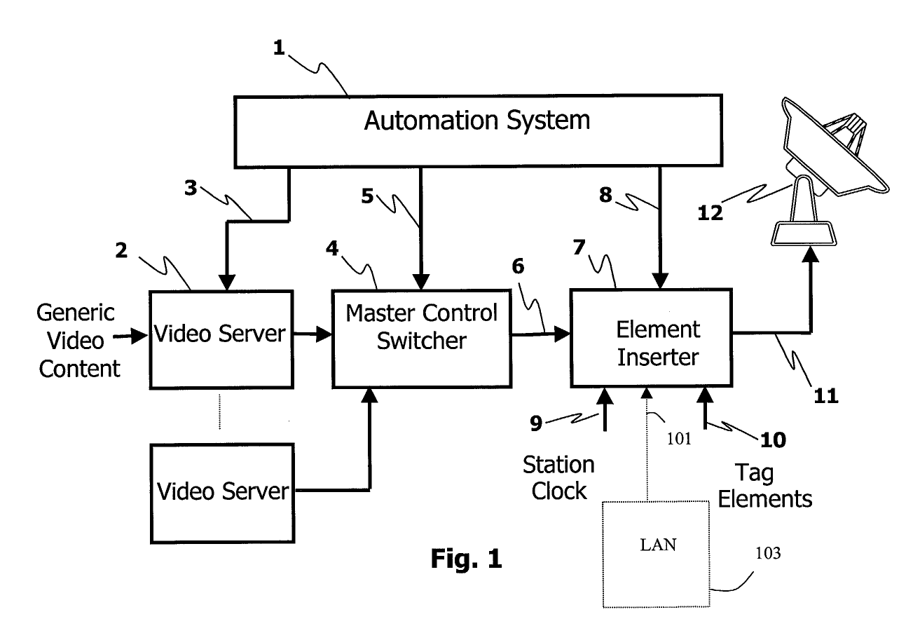

FIG. 1 illustrates a block diagram of one embodiment of a video and audio tag insertion system in accordance with aspects of the invention. The video and audio tag insertion system automates the selection and insertion of tag elements in a broadcast transmission stream. FIG. 1 illustrates the flow of video content and control information within a broadcast facility, including the use of an element inserter.

In the system of FIG. 1, generic video content is transferred into a video server system 2 in preparation for subsequent on-air transmission. As illustrated, the video server system includes a number of video servers, each of which may provide separate content and may be separately controlled. An automation system 1 is connected by a control interface 3 to the video server system 2. The control interface allows the automation system to recall and playback video content as prescribed by, for example, a transmission schedule.

The video servers feed a master control switcher 4. The automation system controls the master control switcher 4 using a second control interface 5, thus allowing the automated selection of various video source devices as required to produce a desired transmission stream. The master control switcher provides a switcher output 6, which is provided as an input to an element inserter system 7. The element inserter system inserts video and/or audio tag elements for inclusion in the transmission stream.

The element inserter system is loaded with video and audio tag elements through a video and audio interface connection 10. The element inserter system is also connected to a source of timing information, which may be the station clock 9. The source of timing information provides a data stream containing the current time-of-day and date. In some embodiments the element inserter is connected to a local area network (LAN) 103 via an interface 101. In such embodiments the LAN may provide the element inserter tag elements in digital format, and in some embodiments a time signal indicating the current time as well.

The automation system 1 is connected through a third control interface 8 to the element inserter 7. The automation system provides the element inserter system by way of the third control interface with information about the video content that is currently being provided by the master control switcher 6. The element inserter system selects, for example as in a manner described below, the appropriate tag elements from its internal storage of audio and video segments and inserts them in the video stream 6, thereby producing a new video stream 11. The new video stream contains the generic video content combined with the tag elements, now ready to go to a transmission system 12. The transmission system is illustrated in FIG. 1 diagrammatically as a satellite uplink station, adapted to transmit content to a satellite for further transmission. In various embodiments, however, the transmission system is, for example, a local broadcast transmitter, a cable transmission system, a server, or other content transmission system.

In one embodiment, the video servers, master control switcher, automation system and transmission system are those commonly found in use in broadcast facilities today. In various embodiments the video servers are video sources, and may include streaming media servers, broadcast video servers, compressed video servers, video playback devices, video tape players, or other video devices.

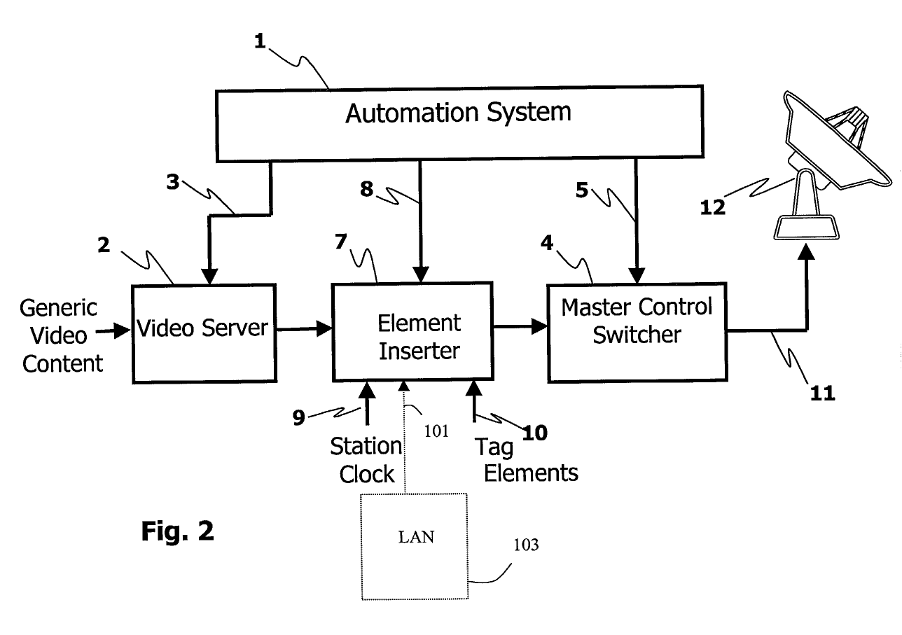

FIG. 2 is a block diagram of an alternate embodiment of a system in accordance with aspects of the invention. In the embodiment of FIG. 2, at least one element inserter is placed prior to the master control switcher in the signal path thereby allowing the insertion of tag elements to occur prior to any signal processing provided by the master control switcher.

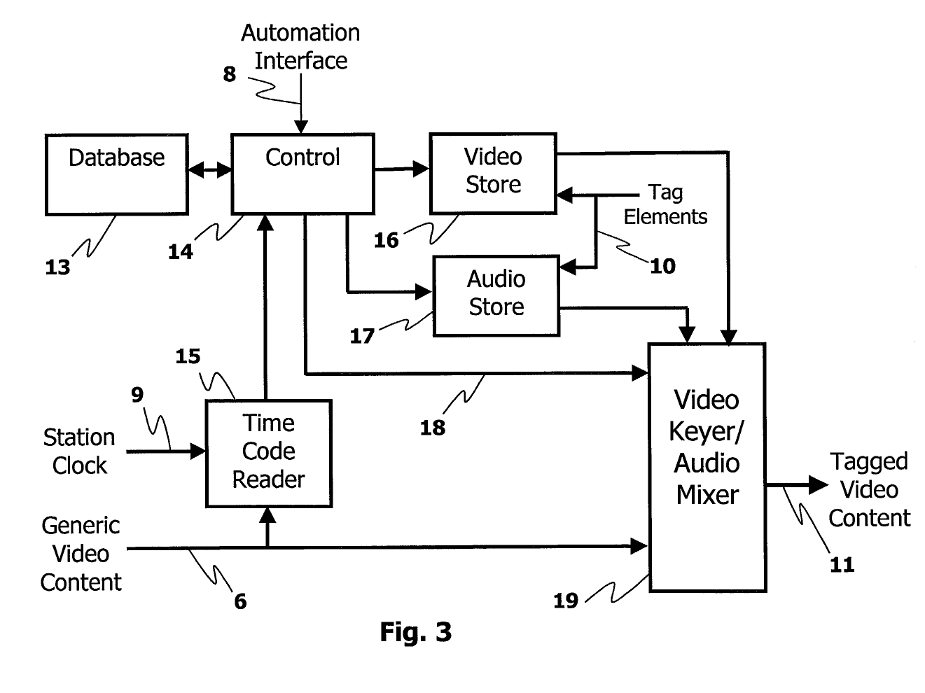

FIG. 3 is a functional block diagram of an embodiment of an element inserter, illustrating internal components and their interconnections. A control 14 controls a video storage function 16 and an audio storage function 17 to allow the loading of video and audio tag elements through an external audio and video interface 10. Information about each tag element is stored in a system database 13 during the element loading process, for later recall during the insertion process described below. The database 13 also stores the program schedule information, input for example by a user when the schedules are first created and as changes occur.

The control 14 also connects to an external automation system through a control interface 8, thereby allowing the control to select appropriate tag elements based upon material identification information provided by the automation system by way of the control interface 8. A station clock data signal 9 is connected to a time code reader function 15, which decodes the station clock data signal and provides the current time of day to the control. A video input connection 6 is connected to a second input of the time code reader function 15, thereby allowing the time code reader to decode the time code signal present in the input video signal and relay to the control 14 the current frame number of the generic video content signal.

The video input 6 is also connected to an input of a video keyer and audio mixer function 19, which allows the combination of the video on input 6 with the video output of the video store function 16 and the mixing of the audio on input 6 with the output of the audio store function 17. The output of the video keyer and audio mixer 11 comprises the output of the element inserter system and provides the combined, or tagged, video content output.

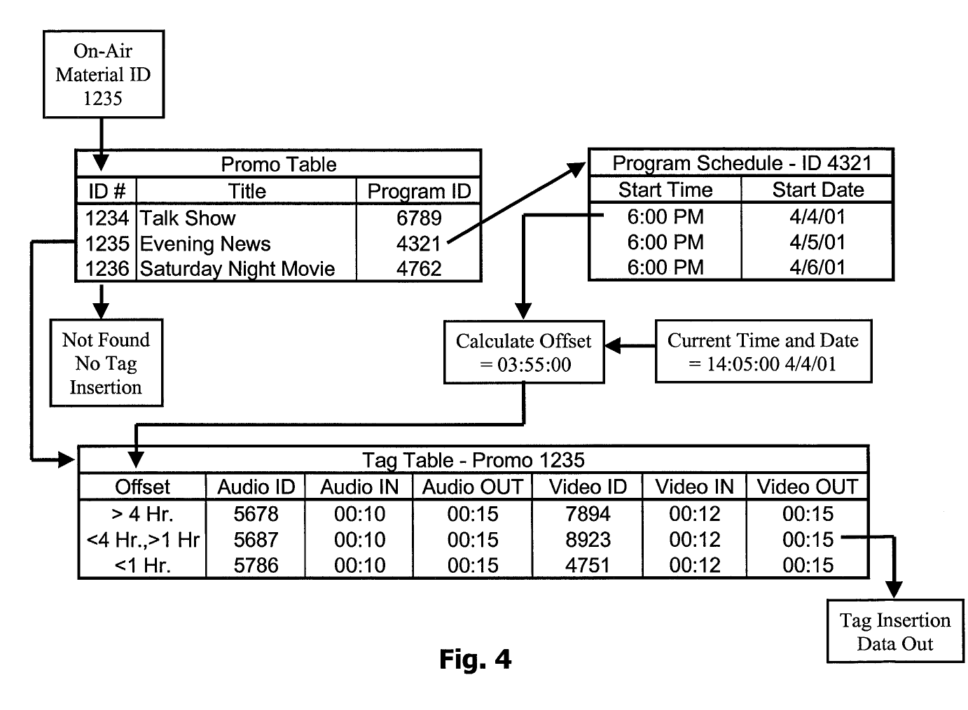

The selection of the appropriate tag elements is accomplished, in one embodiment, by the following process and may be more fully understood by referring to FIG. 3 and FIG. 4:

1. The material identification of the generic video content currently being presented is passed from the automation system 1 to the control 14 via the control interface 8, the control searches the database 13 for a record containing this material ID, if the material ID exists in the database, an associated program identification number is returned to the control. If no record exists matching the generic video's identification number, no tag elements are inserted.

2. The returned program identification number from step 1 is searched for in the database 13 by the control 14, allowing the control to read the next scheduled time and date for the presentation of that program.

3. The control then reads the current time and day information from the Time Code Reader 15, which is derived from the station clock data signal 9. The control then calculates the offset time, in hours, by comparing the next scheduled start time and date of the program, found in step 2 above, to the current time and date read from the time code reader 15.

4. The control 14 then accesses the database 13 to find the stored data defining the tag elements and their edit IN and edit OUT points, associated with the generic video content currently being presented at the offset time calculated in step 3. This data is sent by the control 14 to the video store 16 and the audio store 17 to recall the appropriate video and audio tag elements.

5. The control 14 then compares the current frame number of the generic video content to the programmed IN and OUT edit points found in step 4 by reading the output of the time code reader 15 which derives this data from the generic video input signal 6. When the frame number of the generic video signal matches that of an IN or OUT point for a tag element, the control 14 sends the appropriate on or off control signal to the Video Keyer/Audio Mixer 19 to control the frame accurate insertion of the tag elements over the generic video content signal 6 to form the final tagged video content 11.

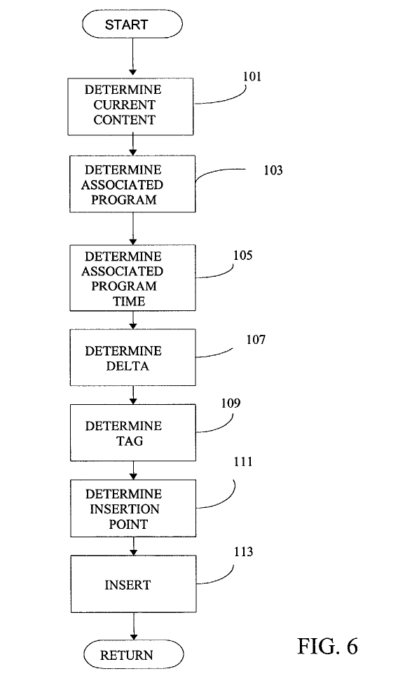

Thus, in one embodiment a system performs a process such as indicated in the flow diagram of FIG. 6. In the process of FIG. 6, in block 101 the process determines a current content. The current content is video content currently being provided to, for example, a transmission system. In block 103 the process determines if a program is associated with the current content. If a program is associated with a current content, the process determines, also in block 103, the program, which may be termed an associated program.

In block 105 the process determines the next show time of the associated program. In block 107 the process determines the time difference between the current time and the next show time of the associated program. In block 109 the process determines a tag based on the associated program and the delta time. In block 111 the process determines a placement point for the tag in the current content. In various embodiments the process, Block 111, determines multiple placements points for the tag or placement points for a number of tags. Moreover, in some embodiments, the placement points may include in point and out points of the tags. In block 113 the process inserts the tag into the current content.

Accordingly, in one embodiment the invention provides a method and system for automatic insertion of information into a broadcast stream, with the information referring to future planned transmissions and based on a varying criteria, specific time. For example, in one embodiment supplemental material for insertion in a video stream is based upon the schedule of future events and the relationship of those events to promotional or commercial material being broadcast. For example, a user enters an inventory of supplemental material. The material is automatically selected for insertion into a transmission stream based upon time dependent rules entered into the system. An example of supplemental material, identified as an insertion message, is indicated below in Table 1. Table 1 also indicates the relationship between the insertion message, a time period, and a content identifier into which the insertion message is to be inserted.

TABLE 1

| Content ID | Day | Time | Insertion Message |
|---|---|---|---|
| 24137 | Monday | All Day | “Saturday night at 8 only |
| | | | on channel 7” |
| 24137 | Tuesday | All Day | “Saturday night at 8 only |
| | | | channel 7” |
| 25628 | Wednesday | All Day | “Saturday night at 8 only |
| | | | on channel 7” |
| 24137 | Thursday | All Day | “Saturday night at 8 only |
| | | | on channel 7” |
| 24137 | Friday | All Day | “Tomorrow night at 8 only |
| | | | on channel 7” |
| 24137 | Saturday | Morning | “Tonight at 8 only on |
| | | | channel 7” |
| 24137 | Saturday | Afternoon | “Tonight at 8 only on |
| | | | channel 7” |
| 25628 | Saturday | 6 PM-7 PM | “Coming up in one hour |
| | | | only on channel 7” |
| 24137 | Saturday | 7 PM-8 PM | “Coming up next only on |
| | | | channel 7” |

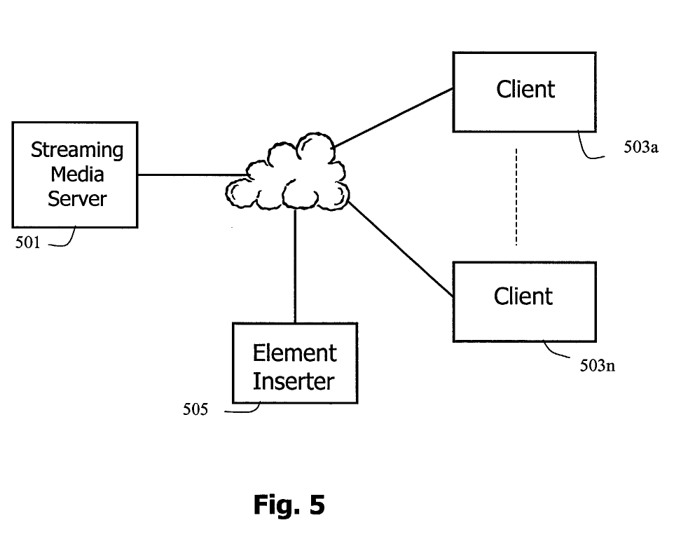

FIG. 5 illustrates the application of the disclosed method for selecting tag elements in a streaming media application. In one embodiment, a streaming media server 501 streams video and/or audio to various clients 503a-n. The clients may be, for example, software such as audiovisual players such as Real Player, etc. The clients receive and output, using display monitors, speakers, and the like, content received from the streaming media server.

While receiving content, at predefined points in time the clients request video and/or audio from an Element Inserter Server 505. In one embodiment, the requests from the clients include information relating to the content received from the streaming media server. Moreover, the information relating to the content received from the streaming media server may relate to the identity of the streaming media server, present programming of the streaming media server, or future programming of the streaming media server. The Element Inserter responds to the request by providing content to the client. In one embodiment the content is determined in a manner as previously described. On receipt of the content the client interrupts playing of content from the streaming media service for a brief period and replaces it with content from the element inserter.

In an alternative embodiment, both the streaming media server and the element inserter provide content to the clients. The content from the streaming media server is generally requested by the client. The content from the element inserter is, in one embodiment, based on a general request for content from the client, with the general request including, for example, future programming information regarding the streaming media server. The element inserter thereafter determines, based on current time and the future programming information, the content to be provided to the client. The content from the streaming media server and the element inserter are thereafter combined by the client, using a time division approach in one embodiment.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention is to be determined by claims supported by this application and their equivalents.

1. A method for including material in a transmission stream, the method comprising:
determining a current content in the transmission stream;
determining a time having an association with the current content;
determining a current time; and
inserting material associated with the current content into the transmission stream based on a relationship between the current time and the time having an association with the current content.

2. The method of claim 1 wherein inserting material associated with the current content into the transmission stream based on a relationship between the current time and the time having an association with the current content comprises mixing audio with audio comprising the current content.

3. The method of claim 1 wherein inserting material associated with the current content into the transmission stream based on a relationship between the current time and the time having an association with the current content comprises inserting video into the transmission stream.

4. The method of claim 3 wherein inserting video into the transmission stream comprises keying video into video comprising the current content.

5. The method of claim 1 wherein inserting material associated with the current content into the transmission stream based on a relationship between the current time and the time having an association with the current content comprises:
inserting material associated with the current content into the transmission stream based on a comparison of the current time and the time having an association with the current content, the comparison determining a difference in time between the current time and the time having an association with the current content.

6. The method of claim 5 wherein inserting material associated with the current content into the transmission stream based on a comparison of the current time and the time having an association with the current content, the comparison determining a difference in time between the current time and the time having an association with the current content, comprises:
determining a time period containing the current time, the time period being referenced to the time having an association with the current content;
determining material associated with the current content for the time period; and
inserting material associated with the current content into the transmission stream.

7. The method of claim 6 wherein the current content is placed into the transmission stream based on a program schedule, the current content is associated with associated content, the associated content being scheduled for later inclusion in the transmission stream by the program schedule at the time having an association with the current content.

8. The method of claim 6 wherein the current content is placed into the transmission stream based on a program schedule, the current content is associated with associated content, the associated content being scheduled for later inclusion in a different transmission stream by another program schedule at the time having an association with the current content.

9. A broadcast system comprising:
at least one video source providing video content;
means for determining a tag for use with the video content based on a current time and a time associated with the video content; and
a combiner for combining the tag and the video content.

10. The broadcast system of claim 9 further comprising means for storing tags.

11. The broadcast system of claim 10 wherein the tags comprise audio content.

12. The broadcast system of claim 11 wherein the combiner comprises an audio mixer.

13. The broadcast system of claim 10 wherein the tags comprise video content.

14. The broadcast system of claim 13 wherein the combiner comprises a video keyer.

15. The broadcast system of claim 9 wherein the means for determining a tag for use with the video content receives a time signal indicating the current time.

16. The broadcast system of claim 15 wherein the means for determining a tag for use with the video content receives an identifier of the video content.

17. The broadcast system of claim 16 wherein the means for determining a tag for use with the video content determines a tag based on information contained in the time signal, information contained in the identifier of the video content, and an expected transmission time of a program associated with the video content.

18. In a system for providing a transmission stream including video content, the transmission of video content in the transmission stream being set by a program schedule, the video content comprising promotional content and program content, the promotional content relating to the program content, a system for including tags in the promotional content, the system comprising:
a tag store storing tags;
a database including information identifying a relationship between tags, promotional content, and program content;
a control receiving an indication of video content in the transmission stream, the control selecting a tag from the tag store using the indication of video content in the transmission stream and information contained in the database; and
a combiner combining the selected tag with the video content in the transmission stream.

19. The system of claim 18 wherein the database includes information of the program schedule.

20. The system of claim 18 wherein at least some of the promotional content has a relationship to multiple tags, and the control selects a one of the multiple tags based on the information of the program schedule and a current time.

21. A method for including material in a transmission stream, the method comprising:
determining a current time;
determining a time associated with a future event;
determining material for insertion into the transmission stream based on a relationship between the current time and the time associated with the future event; and
inserting the material for insertion into the transmission stream.
